(19) United States
(12) Patent Application Publication
(10) Pub. No.: US 2005/0079251 A1
(43) Pub. Date: Apr. 14, 2005

(54) Flexible pouch-bowl arrangement and methods

(76) Inventor: Gary M. Bell, Crystal, MN (US)

Correspondence Address: Merchant & Gould P.C., P.O. Box 2903, Minneapolis, MN, 55402-0903, US

(21) Appl. No.: 10/683,896

(22) Filed: Oct. 10, 2003

(51) Int. Cl. A23B 4/00

(52) U.S. Cl. 426/115

(57) ABSTRACT

A flexible pouch arrangement includes a pouch that can be converted to a pouch-bowl. The pouch-bowl can be eaten directly therefrom. There is a pouch surrounding wall, a gusset closing the bottom end of the pouch surrounding wall, and a score line in the pouch surrounding wall. The score line is spaced from the gusset and from the top end to result in a removable pouch section. The removed section can be used as a lid or splash-guard on the pouch-bowl. One embodiment includes a pair of gripping tabs along the sides to allow for handling and manipulation of the pouch-bowl. Methods of use include removing the removable section, and accessing the material in the bag with an eating utensil. The pouch-bowl can be heated, such as by microwaving, with the removed section acting as a lid or splash-guard.

### TECHNICAL FIELD

This disclosure concerns flexible pouch arrangements, in particular, bottom-gusset, stand-up pouches that can be used as bowls.

### BACKGROUND

A variety of items are marketed and enclosed within flexible bags, pouches, or pouch constructions. Examples include non-edible items, as well as edible items such as pet food, coffee, cookies, rice, salt, candies, etc.

Flexible pouches sometimes have a base, such as a bottom gusset, and are arranged to stand upright when filled. Improvements in the construction and function of flexible pouches are desirable.

### SUMMARY

A flexible pouch arrangement is provided that can be used as a bowl. The pouch arrangement includes a pouch surrounding wall defining an interior volume, a bottom end, and a top end. There is a gusset closing the bottom end of the pouch surrounding wall. In preferred embodiments, there is a score line in the pouch surrounding wall and is spaced from the gusset and from the top end to result in a removable pouch section. The gusset is sized relative to the remaining portions of the pouch section such that it is useable as a bowl.

In preferred embodiments, there are first and second tear notches in the pouch surrounding wall and aligned with the score line.

In certain preferred arrangements, the score line is spaced from the top end so that a dimension of the removable pouch section is greater than or equal to an outermost width of the gusset. This arrangement is useful in having the removable section function as a lid or splash-guard to the remaining section of the pouch.

In some preferred embodiments, there are first and second gripping tabs along the side edges.

A method of using a bottom-gusset, stand-up pouch is provided. One method includes tearing the pouch at a tear notch and along a score line to remove a section of the pouch and leave a remaining pouch-bowl. The remaining pouch-bowl has a bottom-gusset joining first and second wall sections and a bowl rim providing access to an interior of the pouch-bowl. Material, such as food, can then be accessed in the interior of the pouch-bowl.

In some preferred uses, the pouch-bowl can be covered by placing the removed section on the bowl rim to form a lid or splash-guard.

In some preferred methods, the pouch-bowl can be heated, such as placing the pouch-bowl in a microwave. Alternatively, a hot liquid may be poured into the pouch-bowl and to the product in the interior.

In some preferred methods, after the step of heating, the pouch-bowl can be grasped along first and second gripping tabs.

In some preferred methods, the material can be accessed by inserting an eating utensil, such as a spoon, into the interior.

### BRIEF DESCRIPTION OF THE DRAWINGS

FIG. 1 is a top plan view of a first embodiment of a pouch arrangement in a flat orientation, before filling with a product;

FIG. 2 is a perspective view of the pouch arrangement depicted in FIG. 1, shown somewhat smaller and having a product contained therein;

FIG. 3 is a perspective view of the pouch arrangement depicted in FIG. 2 showing the step of removal of a section of the pouch;

FIG. 4 is a perspective view showing the pouch of FIGS. 2 and 3 with the section removed and oriented on the top rim to form a lid or splash-guard; and

FIG. 5 is a perspective view of the pouch arrangement shown in FIGS. 2-4 with the removable section removed and with an eating utensil extending into the interior.

### DETAILED DESCRIPTION

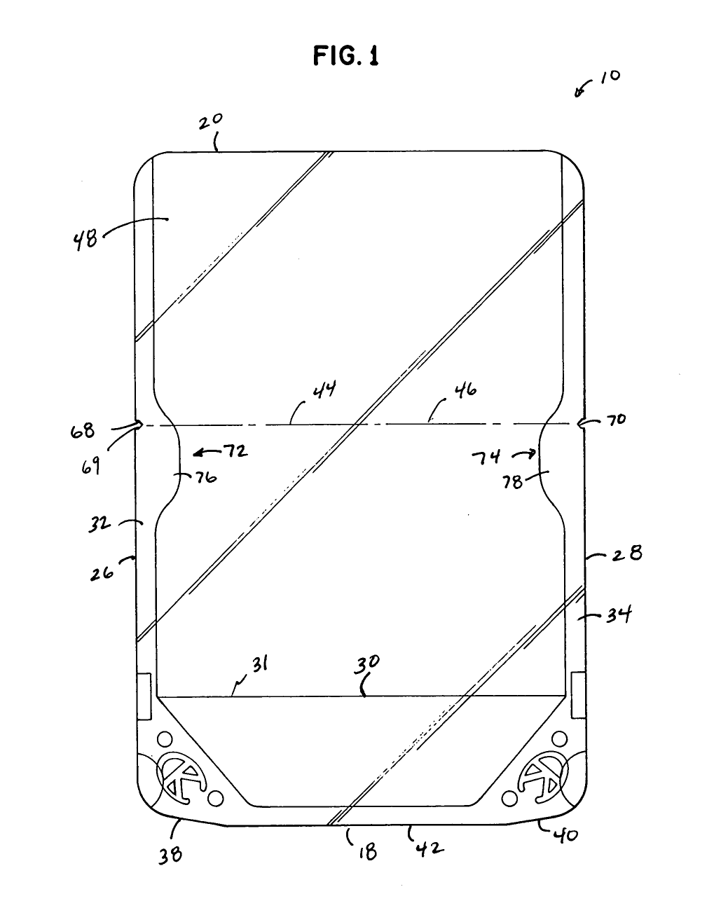

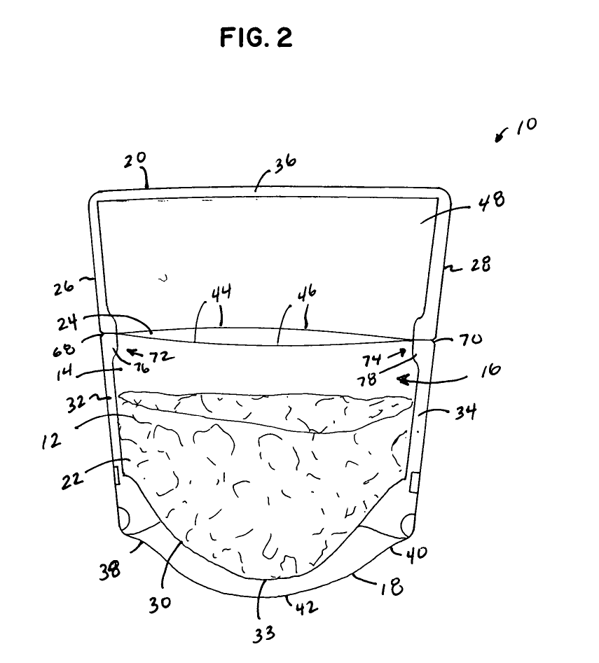

One example of a pouch arrangement constructed according to principles of this disclosure is illustrated in FIG. 1 generally at 10. The pouch arrangement 10 depicted in FIG. 1 is illustrated as it would generally appear prior to being filled or at least partially filled with material 12 (FIGS. 2-6) for storage therein. Such material may include non-edible items, such as soap, shampoo, lotion; or, the material can include edible materials, such as cereal, shelf-stable foods, pet food, snack foods, dehydrated foods edible by adding water or other liquid, noodles, soup, microwaveable foods, etc.

The pouch arrangement 10 depicted includes a pouch surrounding wall 14 (FIG. 2-5) that defines an interior volume 16, a bottom edge or end 18, and a top edge or end 20. The surrounding wall 14 can be constructed of a single piece of flexible material folded over and joined at a single seam, or it can be formed in other ways. In the particular way shown in the FIGS., the surrounding wall 14 is constructed of first and second opposed side walls, panels, or panel sections 22, 24.

Each of the first and second panel sections 22, 24 has a first side edge 26 and a second side edge 28 extending between the top edge or end 20 and the bottom edge or end 18.

A gusset 30 joins the first panel section 22 and the second panel section 24 together adjacent to the bottom end 18. As will be explained further below, in preferred embodiments, the gusset 30 is sized relative to other portions of the pouch arrangement 10 to achieve certain convenient arrangements.

The gusset 30, in the construction shown, is secured to each of the first and second panel sections 22, 24 by use of appropriate sealing, such as heat sealing. In the arrangement shown, the gusset 30 is a separate piece of material attached to the first and second panel sections 22, 24. Alternatively, the gusset 30 can be formed from a single, continuous web of material as the first and second panel sections 22, 24 and folded into a gusset position with respect to the panel sections 22, 24. In FIG. 1, it can be seen how the gusset 30 is folded at fold 31 between the panel sections 22, 24. In FIG. 2, it can be seen that when the pouch arrangement 10 is filled and expanded, the bottom gusset 30 expands to form a base 33 and to support the arrangement in a standing or upright position projecting upwardly from the base 33.

Joining together the first and second panel sections 22, 24 along the first side edge 26 is a first side seal 32. The first side seal 32, in the embodiment shown, is a heat seal, formed by applying a seal bar to the first and second panel sections 22, 24 along the first side edge 26. In the arrangement shown, the first side seal 32 extends completely between the bottom end 18 and the top end 20. In other arrangements, the first side seal 32 can extend only partially toward the top end 20. Analogously, joining together the first and second panel sections 22, 24 along the second side edge 28 is a second side seal 34. The second side seal 34, in the embodiment shown, extends completely between the bottom end 18 and the top end 20. The second side seal 34, in other embodiments, can extend only partially toward the top end 20.

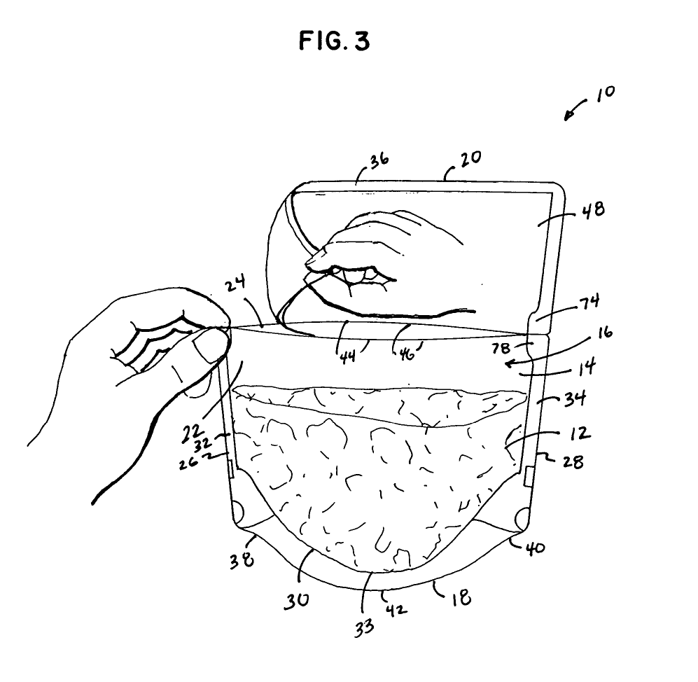

In FIGS. 2 and 3, it can be seen how the first and second panel sections 22, 24 are joined together adjacent to the top end 20 by a top seal 36. In the embodiment shown, the top seal 36 extends between the first side seal 32 and second side seal 34. It should be understood that the top seal 36, in preferred arrangements, is not applied until after material 12 is placed in the interior volume 16. Note that the pouch arrangement 10 in FIG. 1 does not have a top seal 36 at the top end 20. In this way, the pouch arrangement 10 in FIG. 1 can be filled with the desired material 12, and then the top seal 36 applied.

Attention is directed to the bottom end 18 of the pouch arrangement 10 depicted in FIG. 1. The bottom end 18 angles slightly from the horizontal at first and second angled corners 38, 40. Extending between the first angled corner 38 and second angled corner 40 is a straight section 42 of the bottom end 18. The first angled corner 38 and second angled corner 40 is angled sufficiently such that when the pouch arrangement 10 is holding material 12 that expands the gusset 30, the pouch arrangement 10 is steady and does not rock. In the example shown, the first angled corner 38 and second angled corner 40 is angled less than 25°, typically less than 20°, and typically 5-15° relative to the straight section 42.

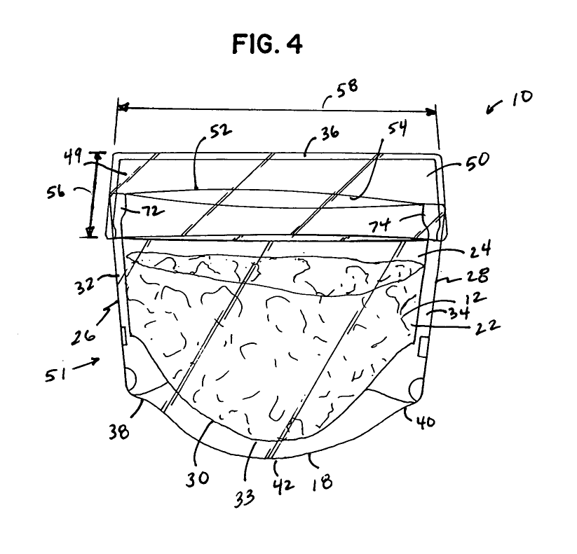

In accordance with principles of this disclosure, there is provided structure to allow for the easy and convenient removal of a portion of the pouch arrangement relative to the rest of the pouch arrangement. In the embodiment shown, a score line 44 is formed in the pouch surrounding wall 14 to allow for removal of a section of the pouch arrangement. The score line 44 can be any of a variety of weakened areas, such as perforation, die-cut lines, or laser score lines. In the embodiment shown, the score line 44 is a laser score line 46 formed in both the first panel section 22 and second panel section 26 in direct opposing relation to each other. In preferred embodiments, the laser score line 46 extends between the first and second side seals 32, 34 and includes the first and second side seals 32, 34. The laser score line 46 is spaced from the bottom gusset 30 and from the top edge 20 to result in a removable pouch section 48. The removable pouch section 48 is useful for forming a cover, splash-guard, or lid 50 (see FIG. 4) as explained further below. Removing the removable pouch section 48 provides access to the material 12 in the interior volume 16.

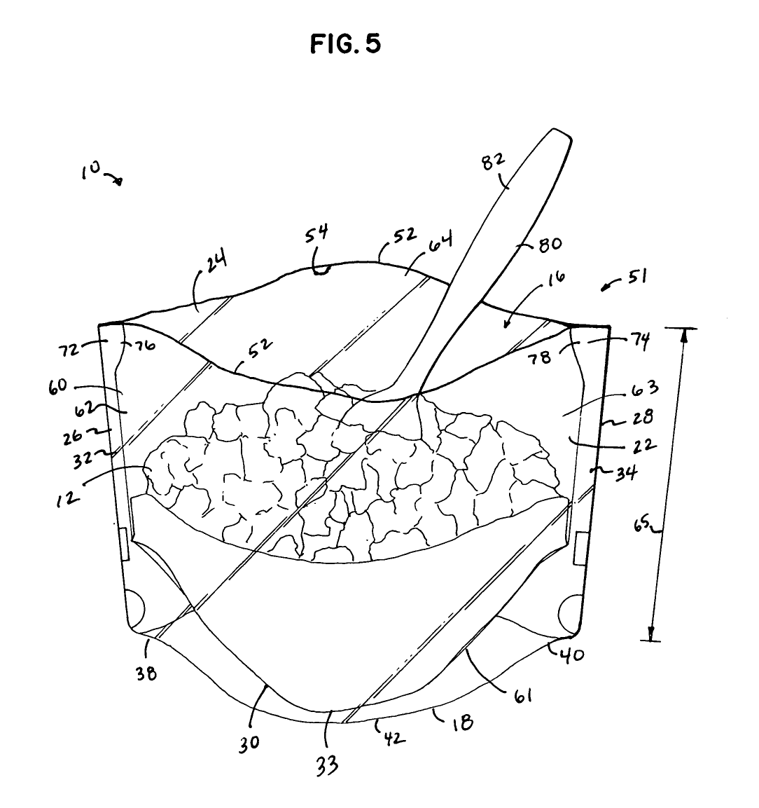

When the removable panel section 48 is removed from the pouch arrangement 10, there are two pieces that result: a removed section 49 (FIG. 4) and a pouch-bowl 51 (FIGS. 4 and 5). The pouch-bowl 51 forms an open mouth 54 (FIG. 5) having a rim 52 (FIG. 5) along the score line 44. The removed section 49 can be used as the lid 50 to rest on the rim 52 and at least partially cover the mouth 54 (FIG. 4).

The score line 44 can be formed along many different places along the length of the pouch arrangement 10. In certain, advantageous embodiments, the score line 44 is positioned relative to the overall length of the first and second panel sections 22, 24, such that the longest dimension of the removable pouch section 48 is at least equal to or greater than an outermost width of the mouth 54 and/or the bottom gusset 30. This geometry results in a convenient, advantageous arrangement because when the removable pouch section 48 is sized so that its longest dimension is equal to or greater than an outermost width of the mouth 54 and/or the bottom gusset 30, then the removed section 49 has a size that allows it to rest on at least a partial portion of rim 52 of mouth 54.

The outermost width of the bottom gusset 30 will generally be the length between the first panel section 22 and second panel section 24 when the gusset 30 is expanded (FIGS. 2-5) at the widest portion of the gusset 30. It will generally correspond to a widest portion across the mouth 54.

In FIG. 4, the removed section 49 has a length 56 extending from the top seal 36 to the edge that was along the score line 44. The removed section 49 has a width 58 that extends between the first and second side seals 32, 34. In certain preferred embodiments, when it is desired to have the removed section 49 function as cover 50, the dimension of either the length 56 or the width 58 is equal to or greater than the outermost width of the bottom gusset 30.

In the embodiment shown in FIGS. 1-5, the score line 44 is located at about 40% of the overall length of the first and second panel sections 22, 24 spaced from the top edge 20. In other arrangements, the score line 44 can be in many other locations, for example, between 30%-60% of the overall length of the first and second panel sections 22, 24 as spaced from the top edge 20.

As mentioned above, the removable section 48 is removed, and results in removed section 49 and pouch-bowl 51. The pouch-bowl 51, in preferred embodiments and in reference to FIG. 5, forms a bowl structure 60 with a bottom 61 and a surrounding wall 62 extending from the bottom 61. As should be apparent, the bottom 61 is formed by the gusset 30. In the embodiment shown, the surrounding wall 62 is formed by the first and second panel sections 22, 24. As shown, the surrounding wall 62 of the bowl structure 60 is formed from opposing first wall 63 and second wall 64. The ends of the walls 63, 64 form the rim 52, which defines the mouth 54. The walls 63, 64 have a height 65 that extends from the bottom end 18 to the end that was defined by the score line 44.

In certain preferred embodiments, the bottom gusset 30 has an outermost width relative to the height 65 of the first and second walls 63, 64 to result in a useable, easily accessible bowl structure 60. While a variety of geometries are possible, some useful arrangements include the bottom gusset 30 having an outermost width that is at least 30% of the height 65 of the first and second walls 63, 64. In some arrangements, the outermost width of the gusset can be at least 50%, and in many useful arrangements, will be 35%-80%. These arrangements allow for convenient, easy access to the interior volume 16.

In certain preferred arrangements, the score line 44 is spaced from the top end 20 so that the length 56 of the removed section 49 is at least 25% of the height 65 of the bowl structure surrounding wall 62. This geometry helps to contribute to a conveniently shaped, accessible bowl structure 60.

In preferred embodiments, the pouch arrangement 10 further includes at least one tear notch 68 aligned with the score line 44. The tear notch 68 helps to start the tear or separation between the removable pouch section 48 and the pouch-bowl 51. In the embodiment shown, the tear notch 68 is shown as a triangular cut 69 (FIG. 1) in the first side seal 32 and aligned with the score line 44. In the particular arrangement shown, there are a pair of tear notches, shown at 68 and 70. The first tear notch 68 is formed in the first side seal 32, while the second tear notch 70 is formed in the second side seal 34. Each of the tear notches 68, 70 is formed at a respective end of the score line 44.

In accordance with principles of this disclosure, in some preferred arrangements, there is a first and second gripping tab to allow for the grasping and handling of the pouch arrangement 10. In general, a first gripping tab 72 will be formed in the first side seal 32 and spaced between the bottom gusset 30 and the score line 44 or first tear notch 68. Analogously, the second gripping tab 74 is in the second side seal 34 and is spaced between the bottom gusset 30 and the score line 44 or second tear notch 70. By the term, “spaced between” it is also meant that the gripping tabs 72, 74 can include part of or be even with the described structure. For example, by stating that the first gripping tab 72 is between the gusset 30 and score line 44 or first tear notch 68, it is meant that the gripping tab 72 can overlap portions of the gusset 30 and overlap portions of the score line 44 and portions of the first tear notch 68.

The gripping tabs 72, 74 allow for a person to grasp the pouch arrangement 10 for movement and handling. This is seen to be particularly convenient and useful when the pouch arrangement 10 has been heated causing the first and second panel sections 22, 24 to be uncomfortably hot for human touch. In the embodiment shown, the first and second gripping tabs 72, 74 are located adjacent to the rim 52 of the pouch-bowl 51. In the embodiment shown, the first and second gripping tabs 72, 74 extend only partially down the first and second walls 63, 64 of the pouch-bowl from the rim 52 along the first and second side seals 32, 34.

In FIGS. 1-3, it can be seen how in the illustrated embodiment, the first and second tear notches 68, 70 extend at least partially into a portion of a respective first and second gripping tab 72, 74. It can also be seen from these Figures that the first gripping tab 72 comprises a portion of the first side seal 32. In particular, in the arrangement shown, the first gripping tab 72 is formed by a first inwardly extending projection 76 of the first side seal 32. In preferred arrangements, the first inwardly extending projection 76 will define a cross-sectional area that is sufficient to allow for opposing fingers of a human hand to grasp it to allow manipulation. In some convenient arrangements, the cross-sectional area is at least 100 mm². In many typical embodiments, the cross-sectional area is 300-1000 mm².

Analogously, the second gripping tab 74 comprises a portion of the second side seal 34. The second gripping tab 74 is formed by a second inwardly extending projection 78 of the second side seal 34. The second inwardly extending projection 78 is also sized sufficient to be comfortably gripped by opposing fingers of a human hand. This size, in one convenient arrangement, will be at least 100 mm², and in many typical arrangements, will be 300-1000 mm².

In the embodiment shown in FIGS. 1-3, the first and second inwardly extending projections 76, 78 are wave-shaped. Another way of describing the shape of the tabs 72, 74 is a rectangle with rounded corners, or an elongated D-shape. The first and second gripping tabs 72, 74, in the arrangement shown, are oriented such that the score line 44 passes through a portion of them, and the resulting pouch-bowl has the gripping tabs 72, 74 oriented adjacent to the rim 52 and adjacent to the upper region of the pouch-bowl 51.

The pouch arrangement 10 can be used in a variety of ways. In one method, the pouch arrangement 10 is torn along the score line 44 to remove the removable pouch section 48 and leave the remaining pouch-bowl 51. This provides access to the interior volume 16 and to the material 12 in the interior 16. The pouch-bowl 51 can then be used as a conventional bowl in conventional applications, such as eating. FIG. 5 illustrates an eating utensil 80, such as a spoon 82, accessing the interior volume 16 through the mouth 54 to scoop up the material 12. The material 12 could be cereal, for example. In such a method, after the removable pouch section 48 is removed, milk can be poured into the pouch-bowl 51, and the cereal consumed. The resulting trash can then be tightly crushed into a small volume for disposal. Such applications can be useful in activities such as camping or in military applications.

In other useful methods, the pouch arrangement 10 is torn along the score line 44 to remove the removable section 48 and leave the pouch-bowl 51 holding the material 12. The removed section 49 is then used to cover the pouch-bowl 51 by placing the removed section 49 on the bowl rim 52 to form cover, splash-guard, or lid 50. This is illustrated in FIG. 4. After the step of covering, the pouch-bowl 51 is heated. This can be done by, for example, placing the covered pouch-bowl 51 into a microwave oven. The lid 50 helps to allow for heating the material 12 in the interior volume 16 and also helps prevent unwanted splashing outside of the interior volume 16. After the step of heating, the first and second walls 63, 64 of the pouch-bowl 51 will be hot. The pouch-bowl 51 can be grasped along the first and second gripping tabs 72, 74 for handling, such as removal from the microwave oven. The gripping tabs 72, 74 are cooler than the first and second walls 63, 64 since they are an area of sealing and increased insulation.

After the step of heating, the lid 50 can be removed from the bowl rim. This can be done before or after the step of grasping. The material 12 can then be consumed from the pouch-bowl 51, such as shown in FIG. 5 by inserting an eating utensil 80 into the material 12.

In general, the step of tearing includes tearing along a first tear notch that is aligned with the score line 44.

The pouch arrangement 10 can be constructed of a variety of flexible materials. In general, the materials of the pouch arrangement 10 are made from a polymeric, non-paper, material. The arrangement shown in the Figures is a transparent, polymeric material. For arrangements that are intended to be used in the microwave oven, the pouch arrangement should be constructed from non-foil laminates. For arrangements that are not going to be used in a microwave oven, the pouch arrangement 10 can be produced in a range of different laminated materials, including foiled laminates, and a variety of graphics. The pouch arrangement 10 can include both retort and non-retort pouches. A retort pouch is one where the product in the pouch is shelf-stable.

The above specification, examples, and data provide a complete description of the invention. Many embodiments can be made.

1. A flexible pouch arrangement comprising:
(a) a pouch surrounding wall defining an interior volume, a bottom end, and a top end;
(b) a gusset closing the bottom end of the pouch surrounding wall;
(c) a score line in said pouch surrounding wall; said score line being spaced from said gusset and from said top end to result in a removable pouch section;
(i) said removable pouch section comprising portions of said pouch surrounding wall between said score line and said top end;
(ii) said score line being spaced from said top end so that a length of said removable pouch section is at least 25% of a height of a remaining portion of the pouch surrounding wall; and
(iii) said gusset having an outermost width of at least 30% of the height of the remaining portion of the pouch surrounding wall.

2. A pouch arrangement according to claim 1 further comprising:
(a) first and second tear notches in said pouch surrounding wall and aligned with said score line.

3. A pouch arrangement according to claim 1 wherein:
(a) said score line is spaced from said top end so that a dimension of said removable pouch section is greater than or equal to an outermost width of said gusset.

4. A pouch arrangement according to claim 1 wherein:
(a) said pouch surrounding wall comprises first and second opposing panel sections joined by first and second side seals.

5. A pouch arrangement according to claim 4 further comprising:
(a) a first gripping tab in said first side seal spaced between said gusset and said score line; and
(b) a second gripping tab in said second side seal spaced between said gusset and said score line.

6. A pouch arrangement according to claim 5 wherein:
(a) said first gripping tab comprises a portion of said first side seal; the first gripping tab being formed by a first inwardly extending projection of the first side seal; the first inwardly extending projection defining a cross-sectional area of at least 100 mm²; and
(b) said second gripping tab comprises a portion of said second side seal; the second gripping tab being formed by a second inwardly extending projection of the second side seal; the second inwardly extending projection defining a cross-sectional area of at least 100 mm².

7. A pouch arrangement according to claim 1 further comprising:
(a) a food product in the interior volume.

8. A flexible pouch arrangement comprising:
(a) first and second opposing panel sections; each of the first and second panel sections having a first and second side edge extending between a top and bottom edge;
(b) a bottom gusset joining the first and second panel sections together adjacent to the first and second panel section bottom edges;
(c) a first side seal joining together the first and second panel sections along respective first side edges;
(i) the first side seal extending between the bottom gusset and at least partially toward the first and second panel section top edges;
(d) a second side seal joining together the first and second panel sections along respective second side edges;
(i) the second side seal extending between the bottom gusset and at least partially toward the first and second panel section top edges;
(e) a score line in said first and second panel sections and extending between said first and second side seals; said score line being spaced from said bottom gusset and from said top edge to result in a removable pouch section;
(i) said removable pouch section comprising portions of said first and second panel sections between said score line and said top edge;
(ii) said score line being spaced from said top edge so that a dimension of said removable pouch section is greater than or equal to an outermost width of said bottom gusset;
(f) a first tear notch in said first side seal aligned with said score line;
(g) a second tear notch in said second side seal aligned with said score line;
(h) a first gripping tab in said first side seal spaced between said bottom gusset and said first tear notch; and
(i) a second gripping tab in said second side seal spaced between said bottom gusset and said second tear notch.

9. A pouch arrangement according to claim 8 wherein:
(a) said first tear notch extends into a portion of said first gripping tab; and
(b) said second tear notch extends into a portion of said second gripping tab.

10. A pouch arrangement according to claim 8 wherein:
(a) said first gripping tab comprises a portion of said first side seal; the first gripping tab being formed by a first inwardly extending projection of the first side seal; the first inwardly extending projection defining a cross-sectional area of at least 100 mm²; and
(b) said second gripping tab comprises a portion of said second side seal; the second gripping tab being formed by a second inwardly extending projection of the second side seal; the second inwardly extending projection defining a cross-sectional area of at least 100 mm².

11. A pouch arrangement according to claim 10 wherein:
(a) the first gripping tab is wave-shaped; and
(b) the second gripping tab is wave-shaped.

12. A method of using a bottom-gusset, stand-up pouch; the method comprising:
(a) tearing the pouch at a tear notch and along a score line to remove a section of the pouch and leave a remaining pouch-bowl; the remaining pouch-bowl having a bottom gusset joining first and second wall sections and a bowl rim providing access to an interior of the pouch-bowl;
(i) the bottom gusset having an outermost width of at least 30% of a height of the first and second wall sections;
(ii) the section of the pouch removed having a length of at least 25% of the height of the first and second wall sections; and
(b) accessing material in the interior of the pouch-bowl.

13. A method according to claim 12 wherein:
(a) the bottom gusset has an outermost width of at least 50% of the height of the first and second wall sections; and
(b) the step of accessing material includes inserting an eating utensil into the interior.

14. A method according to claim 12 wherein:
(a) said step of tearing includes tearing the pouch at a first of a pair of tear notches along a score line.

15. A method of using a bottom-gusset, stand-up pouch; the pouch containing material therein; the method comprising:
(a) tearing the pouch along a score line to remove a section of the pouch and leave a remaining pouch-bowl holding the material; the remaining pouch-bowl having a bottom gusset joining first and second wall sections and a bowl rim providing access to the material in the pouch-bowl;
(b) covering the pouch-bowl by placing the removed section on the bowl rim to form a lid;
(c) after said step of covering, heating the pouch-bowl; and
(d) after said step of heating, grasping the pouch-bowl along first and second gripping tabs.

16. A method according to claim 15 further including:
(a) after said step of heating, removing the lid from the bowl rim.

17. A method according to claim 16 wherein:
(a) said step of removing the lid occurs before said step of grasping.

18. A method according to claim 15 wherein:
(a) said step of tearing includes tearing along a first tear notch aligned with the score line.

19. A method according to claim 15 wherein:
(a) said step of grasping includes grasping the pouch-bowl along first and second gripping tabs;
(i) each of the first and second gripping tabs comprising a portion of a respective side seal of the pouch-bowl; each of the first and second gripping tabs defining a cross-sectional area of at least 100 mm².

20. A method according to claim 19 wherein:
(a) said step of heating includes microwaving the pouch-bowl.
